(19) United States
(12) Patent Application Publication
(10) Pub. No.: US 2026/0204685 A1
(43) Pub. Date: Jul. 16, 2026

(54) COOLING DEVICE FOR ELECTROCHEMICAL AND ELECTROTECHNICAL COMPONENTS

(71) Applicant: CARRAR LTD, Shahar Hanegev (IL)

(72) Inventors: Markus STEPHAN, Gnotzheim (DE); Christoph REICHARDT, Buchdorf (DE); Tom RIEDEL, Weißenburg i. Bay (DE); Werner RUPPERT, Langenaltheim (DE); Eitam FRIEDMANN, Meitar (IL); Ori INBAR, Ruchama (IL); Dor PERETZ, Nevatim (IL); Bar BEN-HORIN, Yeruham (IL)

(21) Appl. No.: 19/134,640

(22) PCT Filed: Nov. 17, 2023
(86) PCT No.: PCT/EP2023/082295

§ 371 Date: May 30, 2025

(30) Foreign Application Priority Data
Dec. 2, 2022 (DE) 10 2022 131 995.4
Dec. 2, 2022 (DE) 20 2022 106 754.6
Mar. 10, 2023 (DE) 10 2023 106 092.9

(51) Int. Cl. H01M 10/6569; H01M 10/613; H01M 50/204

(52) U.S. Cl. CPC H01M 10/6569; H01M 10/613; H01M 50/204

(57) ABSTRACT

The invention relates to a cooling device for electrochemical and electrotechnical components, said cooling device comprising a component housing, wherein the component housing is equipped with an inlet and an outlet, wherein the component housing comprises a main valve and a control valve, wherein the main valve is arranged in a first region of the component housing downstream of the inlet and is designed to control a coolant feed into the component housing, wherein the control valve is arranged in a second region of the component housing and is in fluid connection with the main valve, wherein the control valve is designed to control an opening position of the main valve according to a coolant filling level in the component housing. The invention also relates to a cooling system and to a valve arrangement.

The invention relates to a device for cooling electrochemical or electrotechnical components. In particular, the invention relates to a cooling device for battery cells in moving apparatuses such as vehicles. Moreover, the invention relates to a cooling system and to a valve arrangement.

According to the prior art, it is known that electrochemical or electrotechnical components operate optimally in a predefined temperature window. For components that evolve heat when they operate, the generated heat must be dissipated. Otherwise, overheating of the component may result which, depending on the component, can lead to mere malfunctions of the component or to safety-relevant states.

When multiple single cells are placed in a housing for a battery, it is advantageously known from EP 2 503 199 A1, for example, to cool this battery or battery system. Contact cooling is known in which the contact cooling may function as a pressureless system using water-based media, or as an air conditioner based on hydrofluorocarbons or carbon dioxide. In addition, a pressure compensation device for a battery system is known from EP 2 503 199 A1 which provides an open-pore element to compensate for pressure of a dead volume in the battery system. The known element ensures gas exchange between the battery system and the atmosphere, in particular to avoid overpressure in the event of temperature fluctuations, and thus, damage to the battery system. Thus, this is a system in which gaseous fractions of coolant would be emitted to the atmosphere, resulting in a loss of coolant.

Another system for battery cooling is known from EP 3 113 279 A1, for example. A two-phase fluid is used in the known battery system. The gaseous coolant is either condensed in a topmost module of multiple modules, or is led to a condenser via a gas line. In the known device, a level of the cooling fluid is controlled via an outlet of a lower module. Such control increases the consumption of coolant.

WO 2016/118545 A1 discloses a high performance two-phase cooling apparatus. The cooling apparatus is suitable for cooling semiconductor elements. Heat is absorbed or released via the phase transition between the liquid and the gaseous state. WO 2016/118545 A1 does not relate to control of a filling level.

To obtain an efficacious cooling effect, it is meaningful to control the filling level of the liquid phase.

The object of the invention is to provide a cooling device for electrochemical or electrotechnical components that remedies disadvantages according to the prior art. In particular, the aim is to provide a cooling device that has a controllable coolant filling level.

With regard to the cooling device, the object is achieved by the features of claim 1, and with regard to the valve arrangement is achieved by the features of claim 18. Advantageous embodiments result from the respective subclaims.

The cooling device according to the invention for electrochemical and electrotechnical components comprises a component housing. The component housing is equipped with an inlet and an outlet. The component housing also includes a main valve and a control valve. The main valve is situated in a first area of the component housing downstream from the inlet, and is designed to control a coolant feed into the component housing. The control valve is situated in a second area of the component housing, and is in fluidic connection with the main valve. The control valve is designed to control an open position of the main valve as a function of a coolant filling level in the component housing. That is, when the control valve is open, the main valve opens or is opened, and when the control valve is closed, the main valve closes or is closed.

The housing body in particular has a trough-shaped design.

According to the invention, the cover has an at least two-part design. The first cover element in particular is designed in such a way that the first cover element lies flatly on the housing body, and the first cover element and the housing body delimit an inner space. The outlet and/or inlet are/is selectively provided in the cover or in the housing body. The outlet and the inlet each have an opening, and are advantageously provided for connecting a line or hose to each.

An area of the component housing may be an area of the base or of a side wall of the housing body or an area of the cover; in particular, a first area of the component housing is an area that is different from the second area of the component housing.

In one embodiment, the main valve is situated in an edge area of a cover of the component housing, or at a side face of a component housing body.

The main valve is advantageously designed as a spring-loaded diaphragm valve. The second cover element may be designed as a counterbearing of the spring.

In one embodiment, the main valve has a main valve inlet, a main valve outlet, and a main valve body. The main valve inlet is connected to the inlet. The main valve outlet is connected to an inner space of the component housing. The main valve body has a diaphragm that can be moved between an open position and a closed position. In an open position the main valve inlet, which has a main valve inlet chamber, is connected to the main valve outlet, which has a main valve outlet chamber, and in a closed position there is no fluidic connection through the main valve body between the main valve inlet and the main valve outlet. The diaphragm is advantageously pressed into a closed position by means of the spring. The spring is advantageously a coil spring.

In one embodiment, the control valve is situated, in particular centrally, in a cover of the component housing. Alternatively, the control valve may also be situated in an edge area of the cover.

According to one embodiment, exactly one control valve is provided.

According to an alternative embodiment, two control valves, in particular exactly two control valves, are provided. The two control valves are connected to the main valve in such a way that the main valve closes when both control valves are closed, and the main valve opens when one of the two control valves is opened or both control valves are opened.

The control valves are advantageously situated in a cover of a component housing, in particular in areas of the cover that are remote from one another, for example at opposite edge areas of the cover. Due to the arrangement in the cover at locations that are remote from one another, a coolant filling level may be determined with increased accuracy, in particular when there is tilting of the component housing. The two control valves may have the same or different designs, as described below for a control valve.

In a further embodiment, the control valve is a float valve. A float valve has the advantage that it does not require an additional level sensor. The float valve is situated in the cover of the component housing. The float valve may have a lower stop to limit movement of a floating body downwardly, i.e., away from the cover. This stop may represent a lower threshold value of the coolant filling level. When the float valve is centrally situated, it is more insensitive to inclined positions of the housing body than when it is situated in an edge area.

Within the scope of the present invention, a floating body is understood to mean a body that floats in or on the liquid, the liquid coolant. Such a floating body may be made of a material having a lower density than the liquid, or the floating body may have a cavity that is filled with a gas, in particular air, in particular as an open or closed cavity. The floating body may have, for example, a disk-shaped design or may be provided with a circumferential edge, with the circumferential edge extending, for example, perpendicularly from a main floating body.

Alternatively, the control valve may be designed as an electromagnetic valve. In this embodiment, a sensor is additionally provided which controls the control valve as a function of a filling level. A sensor is advantageously situated in a central area in the vicinity of the cover.

The float valve advantageously has a floating body with a sealing element, wherein with the sealing element the floating body closes an opening in the control valve when the coolant that is accommodated in the inner space of the component housing exceeds an upper threshold value of a coolant filling level. The floating body opens the float valve when a coolant filling level is below an upper threshold value, the floating body being led in particular in a guide situated in the inner space of the component housing.

In one alternative embodiment, the float valve has a floating body and a lever with a sealing element, wherein the sealing element closes an opening in the control valve when the coolant that is accommodated in the inner space of the component housing exceeds an upper threshold value of a coolant filling level. With the lever, the floating body opens the float valve when a coolant filling level is below an upper threshold value. The lever is in particular articulately connected to the cover, in particular to the first cover element, on one side, and is rigidly or articulately connected to the floating body on the opposite, other side. The floating body may in particular be led in a guide situated in the inner space of the component housing.

A control channel is advantageously situated between the main valve and the control valve, the control channel being connected to an inlet via a throttle situated in the main valve, and the control channel being connected to an inner space of the component housing via the control valve, and in an open state of the control valve the inlet being fluidically connected through the control channel to the inner space of the component housing via the throttle.

In particular, coolant can flow from the inlet, through the control channel via the throttle, and into the inner space of the component housing.

In one embodiment with two control valves, a first section of a control channel is advantageously situated between the main valve and one of the two control valves, and a second section of the control channel is situated between the two control valves. The first section of the control channel is connected to an inlet via a throttle situated in the main valve, and the control channel is connected to an inner space of the component housing via the control valve(s). In an open state of both control valves or of at least one control valve, the inlet is connected through the control channel to the inner space of the component housing via the throttle.

Alternatively, a control channel may also be provided between the main valve and each of the control valves.

In one embodiment, the cover includes a first cover element with an inner side and an outer side, and a second cover element with an inner side and an outer side, the control channel being formed by a cavity between the first and the second cover elements. The control channel may in particular be formed by side walls that extend from the first cover element to the second cover element, and/or by a groove that is formed in the first cover element. Alternatively, the control channel may be formed by a tubular element.

In a further embodiment, one or more battery elements or accumulator elements are accommodated in the component housing.

In one embodiment, semi-permeable elements that lead gaseous coolant from an inner space to the outlet are situated in the component housing, in particular in the first cover element.

According to a further aspect, the invention relates to a valve arrangement made up of two control valves and a main valve, which are designed in particular for use with the cooling system according to the invention. The two control valves and the main valve are situated at a component housing which is provided at least with an inlet. The two control valves are connected to the main valve in such a way that the main valve closes when both control valves are closed, and the main valve opens when one of the two control valves is opened or both control valves are opened.

The control valves are advantageously situated in a cover of a component housing, in particular in areas of the cover that are remote from one another, for example opposite edge areas of the cover. Due to the arrangement in the cover at locations that are remote from one another, a coolant filling level may be determined with increased accuracy, in particular when there is tilting of the component housing. The control valves are designed in particular as float valves, for example as described above.

According to a further aspect of the invention, a cooling system is disclosed which includes the cooling device and also includes a radiator and a compressor that are situated outside the component housing. The cooling device, compressor, and radiator are connected to one another via lines. The compressor and the radiator reliquefy the gaseous coolant. Alternatively, the cooling system may also include a heat exchanger or condenser that is situated outside the component housing and reliquefies the gaseous coolant. The cooling system forms a closed circuit.

The invention is explained in greater detail below with regard to further features and advantages, based on the description of exemplary embodiments and with reference to the appended drawings. The figures show the following, in each case in a schematic diagram:

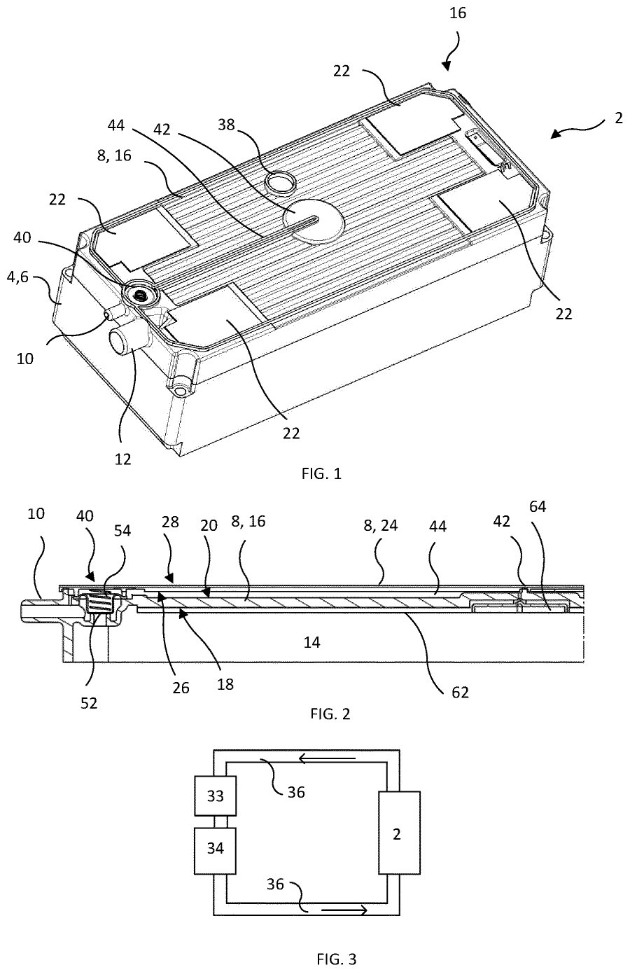

FIG. 1 shows a top view of a partially open component housing of a first embodiment,

FIG. 2 shows a longitudinal section along A-A according to FIG. 1,

FIG. 3 shows a cooling system,

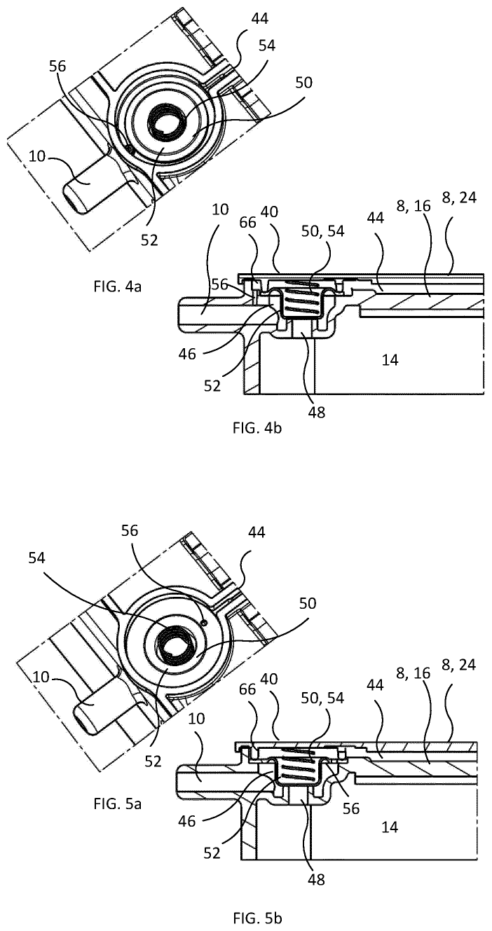

FIGS. 4a, 4b show a detailed view of a main valve in a first embodiment,

FIGS. 5a, 5b show a detailed view of a main valve in a second embodiment,

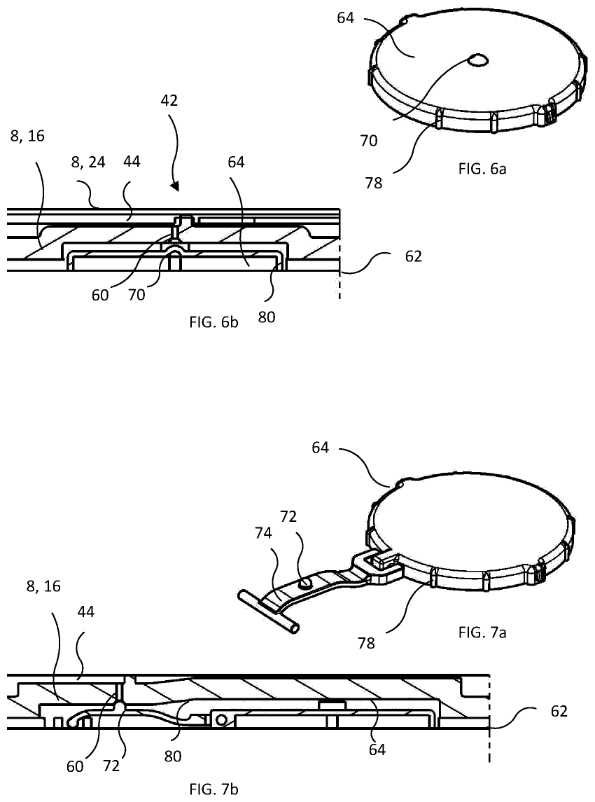

FIGS. 6a, 6b show a detailed view of a control valve in a first embodiment,

FIGS. 7a, 7b show a detailed view of a control valve in a second embodiment,

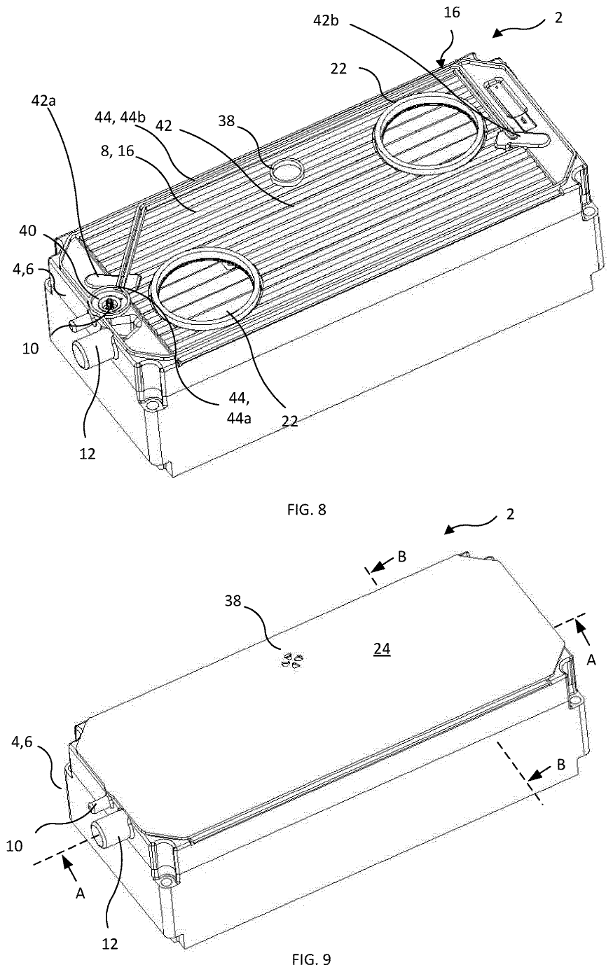

FIG. 8 shows a top view of a partially open component housing of a second embodiment,

FIG. 9 shows a top view of a closed component housing,

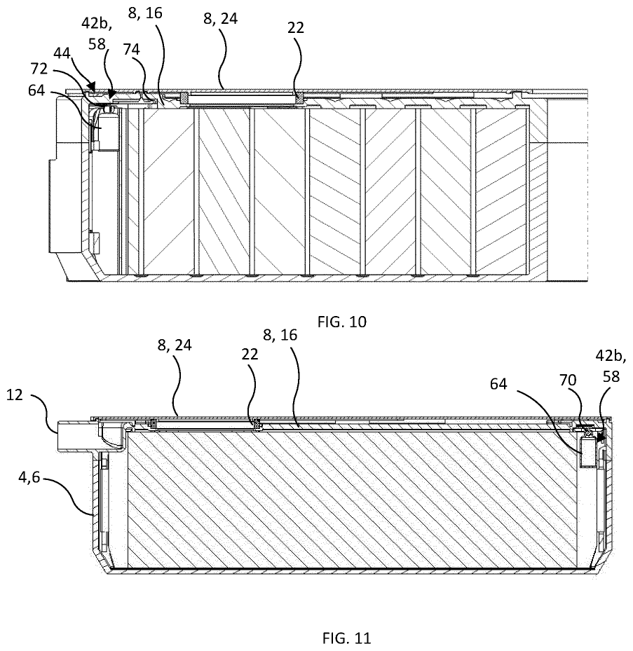

FIG. 10 shows a cross section along B-B from FIG. 9, and

FIG. 11 shows a longitudinal section along A-A from FIG. 9.

The cooling device 2 according to the invention illustrated in FIG. 1 comprises a component housing 4. The component housing 4 has a housing body 6 and a cover 8. The housing body 6 has a trough-shaped design, and the cover 8 closes an inner space of the housing body 6. The component housing 2 is also provided with an inlet 10 and an outlet 12. In the embodiment shown, the inlet 10 and the outlet 12 each have a tubular protrusion. The cover 8 has a first cover element 16 on its top side. Situated above the first cover element 16 is a second cover element 24, which is omitted in FIG. 1 but illustrated in FIG. 2. The first cover element 16 has an inner side 18 and an outer side 20, and the second cover element 24 has an inner side 26 and an outer side 28. The outer side 20 and the inner side 26 are situated opposite one another.

The control channel 44 is formed by a cavity between the first cover element and the second cover element 24.

A main valve 40 is situated in the cover 8 (in the present embodiment, in the first cover element 16). The main valve 40 is fluidically connected to the inlet 10. In addition, a control valve 42 is centrally situated in the first cover element 16. A control channel 44 is situated in the first cover element 16 and is fluidically connected to the main valve 40 and to the control valve 42. The control channel 44 here is formed by side walls that extend from the first cover element to the second cover element, and optionally by a groove that is formed in the first cover element. The first cover element 16 optionally includes semi-permeable elements for discharging gaseous coolant that is supplied to the outlet 12. In this case, the control channel 44 is separated, by the side walls, from a gap between the first cover element 16 and the second cover element 24 through which the gaseous coolant is led, i.e., is not fluidically connected thereto.

FIG. 2 shows a longitudinal section of the cooling device along A-A in FIG. 1. The inlet 10 is connected to the main valve 40. When the main valve 40 is opened, coolant is led from the inlet 10 and into an inner space 14 of the component housing 4. When the main valve 40 is closed, the inlet 10 is blocked. The main valve 40 has a diaphragm 52 and a spring 54 in the embodiment shown. In the first cover element 16 a control channel 44 extends from the main valve 40. In the present case, the control channel 44 is closed at the top by the second cover element 24. The control channel 44 extends to the control valve 42, and forms a fluidic connection between the main valve 40 and the control valve 42.

The control valve 42 is designed as a float valve 58. The float valve has a floating body 64 and an opening 60. The control valve 42 is opened or closed by the floating body 64 as a function of a coolant filling level 62.

The cooling system according to the invention is illustrated in FIG. 3. The cooling device 2 with its outlet 12 is connected via a line 36 to a radiator 34 and a compressor 33, which reliquefy the gaseous coolant. The liquid coolant may then be resupplied to the cooling device 2 via a line 36, so that the liquid coolant passes once again into the inner space 14 of the component housing via the inlet 10 when the main valve 40 is opened. In the component housing, the coolant is reheated by the waste heat from components, in particular battery cells, accommodated in the component housing, and is at least partially converted into the gaseous phase. Coolant, in particular gaseous coolant, is led back to the compressor via the outlet 12.

FIGS. 4a and 4b show the main valve 40 in a first embodiment in greater detail. The main valve 40 has a main valve inlet 46 and a main valve outlet 48. The main valve also has a main valve body 50 in which a diaphragm 52 and a spring 54 are situated. The diaphragm 52 seals the valve with respect to a valve seat 68 in the closed state. In the open state a gap is formed between the diaphragm 52 and the valve seat 68. The spring 54, which may be designed as a coil spring, presses the diaphragm 52 against the valve seat 68. The spring 54 is supported against the second cover element 24 at the side opposite from the valve seat 68. The second cover element 24 advantageously has a flange 66 that seals off the main valve body 50 toward a top side and encloses the spring 54 in the circumferential direction. The control channel 44 extends from the main valve body 50. In addition, the inlet 10 or the main valve inlet 46 is fluidically connected to the control channel 44 via a throttle 56.

In the embodiment shown in FIGS. 4a and 4b, the throttle 56 is situated in the component housing 4 and is designed as a channel in particular in the housing body 6.

FIGS. 5a and 5b show a second embodiment of the main valve 40. This second embodiment of the main valve 40 differs from the first embodiment by the position of the throttle 56. In this embodiment the throttle 56 is situated in the diaphragm 52. Also in this embodiment, the throttle 56 provides a connection between the inlet 10 and the control channel 44.

FIGS. 6a and 6b show a first embodiment of the control valve 42. The control valve 42 has an opening 60 that connects the control channel 44 to the inner space 14 of the component housing 4. The control valve 42 has a floating body 64. In this embodiment the floating body 64 has an essentially cylindrical design. The floating body 64 has a centrally situated sealing element 70. At its circumferential edge the floating body 64 has protrusions 78 that can engage with guide grooves. In the embodiment shown, around the opening 60 at its inner side 18 the first cover element is provided with an indentation 80 which can at least partially accommodate the floating body 64.

FIGS. 7a and 7b show a second embodiment of the control valve 42. The control valve 42 is likewise designed as a float valve 58, and has a floating body 64. Unlike the embodiment illustrated in FIGS. 6a and 6b, the floating body 64 is connected to the component housing 4 via a lever 74. In particular, the component housing 4 has a bearing 76 via which the lever 74 is articulately connected to the component housing 4 at a first side. At a second side the lever 74 is articulately connected to the floating body 64. A sealing element 72 that tightly closes the opening 60 in the first cover element 16 in a closed state of the control valve 42 is situated on the lever 74, i.e., on a side facing the first cover element 16. The advantage of this embodiment is that the control valve 42 may be closed even when there are fairly high pressures in the control channel 44.

The operating principle of the control valve of the first and second embodiments is as follows: the floating body 64 floats on the coolant that is present in the inner space 14 of the component housing 4. When a coolant filling level 62 exceeds a predetermined threshold value, the upper threshold value, the sealing element 70, 72 is pressed against the opening 60, so that the control valve 42 closes. Due to the closed control valve 42, a pressure increases in the control channel 44 which is connected to the inlet 10 via the throttle 56. The spring-loaded main valve 40 is brought into its closed position as a result of this pressure increase. The coolant filling level 62 is thus limited to the upper threshold value, since further coolant cannot subsequently flow into the inner space 14. When the coolant filling level 62 falls below the upper threshold value in the inner space 14, the floating body 64 sinks and the sealing element 70, 72 frees up the opening 60 in the control valve 42. Due to freeing up the opening 60 in the control valve 42, to a small extent coolant can pass through the control channel 44 and the opening 60 into the inner space 14. More importantly, however, a pressure in the control channel 44 decreases, and the spring-loaded main valve 40 is thus brought from its closed position into an open position. Coolant may thus be led once again from the inlet 10, through the main valve 40, and into the inner space 14. The coolant filling level 62 is once again replenished up to the upper threshold value.

The embodiment of the cooling device 2 illustrated in FIG. 8 includes a component housing 4. The component housing 4 has a housing body 6 and a cover 8. The housing body 6 has a trough-shaped design, and the cover 8 closes an inner space of the housing body 6. The component housing 2 is also provided with an inlet 10 and an outlet 12. In the embodiment shown, the inlet 10 and the outlet 12 each have a tubular protrusion. The cover 8 has a first cover element 16 on its top side. Situated above the first cover element 16 is a second cover element 24, which is omitted in FIG. 8 but illustrated in FIG. 9. The first cover element 16 has an inner side 18 and an outer side 20, and the second cover element 24 has an inner side 26 and an outer side 28. The outer side 20 and the inner side 26 are situated opposite one another.

The control channel 44 is formed by a cavity between the first cover element 16 and the second cover element 24.

In the cover 8, in this embodiment a main valve 40 is situated in the first cover element 16. The main valve 40 is fluidically connected to the inlet 10. In addition, two control valves 42a, 42b are situated in the first cover element 16. A control channel 44 is situated in the first cover element 16 and is fluidically connected to the main valve 40 and to the control valves 42a, 42b. The main valve 40 may be designed as shown in FIG. 4a, 4b or 5a, 5b.

The control valve 42a is situated adjacent to the main valve 40. The control valve 42a is fluidically connected to the main valve 40 via a first section 44a of the control channel 44. The control valve 42b is situated on the remote side of the cover element 16 in the longitudinal direction of the component housing 4. The control valve 42b is fluidically connected to the control valve 42a via a second section 44b of the control channel 44.

The configuration of the control valve 42b is also illustrated in a longitudinal section in FIG. 10, and in a cross section in FIG. 9. The control valve 42b is situated at an edge of the component housing 4, in particular on the side facing away from the outlet 12. The control valve 42b is designed as a float valve 58. The float valve has a floating body 64 that moves away from the cover 8 or toward the cover 8, as a function of a coolant filling level at the floating body. The float valve 58 also has a sealing element 70 that can open or close a seal seat of the valve. The floating body 64 is connected to the first cover element 16 via a lever 74, as illustrated in FIG. 10. The floating body may be led in a guide at a side wall of the housing body 6. The other control valve 42a of the two control valves advantageously has the same design.

The control channel 44 is formed here by side walls that extend from the first cover element 16 to the second cover element 24, and optionally by a groove that is formed in the first cover element. The first cover element 16 optionally includes semi-permeable elements 22 for discharging gaseous coolant that is supplied to the outlet 12. In this case, the control channel 44 is separated, by the side walls, from a gap 30 between the first cover element 16 and the second cover element 24 through which the gaseous coolant is led, i.e., is not fluidically connected thereto. The control channel as illustrated in FIG. 8 has a first section 44a and a second section 44b. The first section 44a extends from the main valve 30 to the control valve 42a, and the second section 44b extends from the control valve 42a to the control valve 42b. As soon as one of the two control valves 42a, 42b is opened, the pressure in the control channel 44 drops in such a way that the main valve 40 opens at the pump pressure that is present at the inlet.

### LIST OF REFERENCE NUMERALS

2 cooling device
4 component housing
6 housing body
8 cover
10 inlet
12 outlet
14 inner space
16 first cover element
18 inner side
20 outer side
22 semi-permeable element
24 second cover element
26 inner side
28 outer side
33 compressor
34 radiator
36 lines
38 safety element
40 main valve
42, 42a, 42b control valve
44 control channel
44a first section
44b second section
46 main valve inlet
48 main valve outlet
50 main valve body
52 diaphragm
54 spring
56 throttle
58 float valve
60 opening
62 coolant filling level
64 floating body
66 flange
68 valve seat
70 sealing element
72 sealing element
74 lever
76 lever bearing
78 protrusions
80 indentation

1. A cooling device for electrochemical and electrotechnical components, comprising
a component housing,
wherein the component housing is equipped with an inlet and an outlet,
wherein the component housing includes a main valve and a control valve,
wherein the main valve is situated in a first area of the component housing downstream from the inlet, and is designed to control a coolant feed into the component housing,
wherein the control valve is situated in a second area of the component housing and is in fluidic connection with the main valve, the control valve being designed to control an open position of the main valve as a function of a coolant filling level in the component housing.

2. The cooling device according to claim 1, including exactly one control valve.

3. The cooling device according to claim 1, wherein a control channel is situated between the main valve and the control valve, the control channel being connected to an inlet via a throttle situated in the main valve, and the control channel being connected to an inner space of the component housing via the control valve, and in an open state of the control valve the inlet being fluidically connected through the control channel to the inner space of the component housing via the throttle valve.

4. The cooling device according to claim 1, including two control valves, in particular exactly two control valves.

5. The cooling device according to claim 2, wherein the main valve closes when both control valves are closed, and the main valve opens when one of the two control valves is opened or both control valves are opened.

6. The cooling device according to claim 4, wherein the control valves are situated in a cover of the component housing, in particular in areas of the cover that are remote from one another.

7. The cooling device according to claim wherein a first section of a control channel is situated between the main valve and the first of the two control valves, the first section of the control channel being connected to an inlet via a throttle situated in the main valve, and the first section of the control channel being connected to an inner space of the component housing via the control valve,
wherein the second of the two control valves is connected to the first of the two control valves via a second section of the control channel, and in an open state of at least one control valve the inlet is fluidically connected through the control channel to the inner space of the component housing via the throttle.

8. The cooling device according to claim 3, wherein the cover includes a first cover element with an inner side and an outer side, and a second cover element with an inner side and an outer side, wherein the control channel is formed by a cavity between the first cover element and the second cover element.

9. The cooling device according to claim 1, wherein the main valve is situated in an edge area of a cover of the component housing, or at a side face of a component housing body.

10. The cooling device according to claim 1, wherein the main valve is designed as a spring-loaded diaphragm valve.

11. The cooling device according to claim 1, wherein the main valve has a main valve inlet, a main valve outlet and a main valve body,
wherein the main valve inlet is connected to the inlet,
wherein the main valve outlet is connected to an inner space of the component housing,
wherein the main valve body has a diaphragm that can be moved between an open position and a closed position, in an open position the main valve inlet being connected to the main valve outlet, and in a closed position there being no fluidic connection through the main valve body between the main valve inlet and the main valve outlet.

12. The cooling device according to claim 1, wherein the control valve is situated in a cover of the component housing.

13. The cooling device according to claim 1, wherein the control valve(s) is/are a float valve.

14. The cooling device according to claim 13, wherein the float valve has a floating body and a lever with a sealing element, wherein with the sealing element the floating body closes an opening in the control valve when a coolant that is accommodated in the inner space of the component housing exceeds an upper threshold value of a coolant filling level, and wherein the floating body opens the float valve when a coolant filling level is below an upper threshold value, the floating body being led in particular in a guide situated in the inner space of the component housing

15. The cooling device according to claim 13, wherein the float valve has a floating body and a lever with a sealing element, wherein the sealing element closes an opening in the control valve when a coolant that is accommodated in the inner space of the component housing exceeds an upper threshold value of a coolant filling level,
and wherein the floating body opens the float valve with the lever when a coolant filling level is below an upper threshold value.

16. The cooling device according to claim 1, wherein one or more battery elements or accumulator elements are accommodated in the component housing.

17. A cooling system that includes a cooling device according to claim 1, and a radiator and a compressor.

18. A valve arrangement, in particular for a cooling device, comprising two control valves and a main valve, the two control valves being connected to the main valve in such a way that the main valve closes when both control valves are closed, and the main valve opens when one of the two control valves is opened or both control valves are opened, the control valves being situated in particular in a cover of a component housing.
